(19) United States
(12) Patent Application Publication
(10) Pub. No.: US 2022/0281000 A1
(43) Pub. Date: Sep. 8, 2022

(54) SINTERED MATERIAL AND METHOD FOR PRODUCING SINTERED MATERIAL

(71) Applicants: Sumitomo Electric Industries, Ltd., Osaka-shi, Osaka (JP); Sumitomo Electric Sintered Alloy, Ltd., Takahashi-shi, Okayama (JP)

(72) Inventors: Tomoyuki ISHIMINE, Osaka-shi, Osaka (JP); Shigeki EGASHIRA, Osaka-shi, Osaka (JP); Kazunari SHIMAUCHI, Osaka-shi, Osaka (JP); Takayuki TASHIRO, Osaka-shi, Osaka (JP)

(73) Assignees: Sumitomo Electric Industries, Ltd., Osaka-shi, Osaka (JP); Sumitomo Electric Sintered Alloy, Ltd., Takahashi-shi, Okayama (JP)

(21) Appl. No.: 17/637,809

(22) PCT Filed: Aug. 30, 2019
(86) PCT No.: PCT/JP2019/034296

§ 371 Date: Feb. 24, 2022

(51) Int. Cl. B22F 3/11; C22C 38/12; C22C 38/08; C22C 38/04; B22F 5/08

(52) U.S. Cl. CPC B22F 3/1103; C22C 38/12; C22C 38/08; C22C 38/04; B22F 5/08; B22F 2301/35; F16H 55/06

(57) ABSTRACT

A sintered material containing a parent phase composed of a metal and a plurality of pores present in the parent phase, wherein the pores in a cross section have an average cross-sectional area of 500 μm² or less, and the sintered material has a relative density in the range of 93% to 99.5%.

### TECHNICAL FIELD

The present disclosure relates to a sintered material and a method for producing the sintered material.

### BACKGROUND ART

Patent Literature 1 discloses an iron-based sintered body with a relative density of 93% or more.

### CITATION LIST

### Patent Literature

PTL 1: Japanese Unexamined Patent Application Publication No. 2017-186625

### SUMMARY OF INVENTION

A first sintered material according to the present disclosure contains

a parent phase composed of a metal, and

a plurality of pores present in the parent phase,

wherein the pores in a cross section have an average cross-sectional area of 500 μm² or less, and

the sintered material has a relative density in the range of 93% to 99.5%.

A second sintered material according to the present disclosure contains

a parent phase composed of a metal, and

a plurality of pores present in the parent phase,

wherein the pores in a cross section have an average perimeter of 100 μm or less, and

the sintered material has a relative density in the range of 93% to 99.5%.

A method for producing a sintered material according to the present disclosure includes the steps of

compressing a raw powder to produce a green compact with a relative density in the range of 93% to 99.5%, and

sintering the green compact,

wherein the raw powder contains a powder composed of an iron-based material with a Vickers hardness Hv in the range of 80 to 200, and

a sintering temperature in the step of sintering the green compact is 1000° C. or more and less than 1300° C.

### BRIEF DESCRIPTION OF DRAWINGS

FIG. 1 is a perspective view of an example of a sintered material according to an embodiment.

FIG. 2A is a photomicrograph of a cross section of a sintered material of sample No. 1 prepared in a test example 1.

FIG. 2B is a photomicrograph of a cross section of a sintered material of sample No. 2 prepared in the test example 1.

FIG. 2C is a photomicrograph of a cross section of a sintered material of sample No. 3 prepared in the test example 1.

FIG. 3 is a graph showing the average cross-sectional area of pores in a sintered material of each sample prepared in the test example 1.

FIG. 4 is a graph showing the average perimeter of the pores in the sintered material of each sample prepared in the test example 1.

FIG. 5 is a graph showing the average maximum diameter of the pores in the sintered material of each sample prepared in the test example 1.

FIG. 6 is a graph showing the maximum value of the maximum diameters of the pores in the sintered material of each sample prepared in the test example 1.

FIG. 7 is a graph showing the minimum value of the maximum diameters of the pores in the sintered material of each sample prepared in the test example 1.

FIG. 8A is a photomicrograph of a cross section of a sintered material of sample No. 101 prepared in the test example 1.

FIG. 8B is a photomicrograph of a cross section of a sintered material of sample No. 102 prepared in the test example 1.

FIG. 8C is a photomicrograph of a cross section of a sintered material of sample No. 103 prepared in the test example 1.

### PROBLEMS TO BE SOLVED BY PRESENT DISCLOSURE

There is a need for a sintered material with high strength and productivity.

Accordingly, it is an object of the present disclosure to provide a sintered material with high strength and productivity. It is another object of the present disclosure to provide a method for producing a sintered material capable of producing a high-strength sintered material with high productivity.

### Advantageous Effects of Present Disclosure

A sintered material according to the present disclosure has high strength and productivity. A high-strength sintered material can be produced with high productivity by a method for producing a sintered material according to the present disclosure.

### DESCRIPTION OF EMBODIMENTS OF PRESENT DISCLOSURE

First, embodiments of the present disclosure are described below.

(1) A sintered material according to an embodiment of the present disclosure contains

a parent phase composed of a metal, and

a plurality of pores present in the parent phase,

wherein the pores in a cross section have an average cross-sectional area of 500 μm² or less, and

the sintered material has a relative density in the range of 93% to 99.5%.

The sintered material according to this embodiment of the present disclosure may be hereinafter referred to as a first sintered material.

As described below, the first sintered material is less susceptible to cracking caused by pores and therefore has high strength and productivity.

### (Strength)

The first sintered material has a relative density of 93% or more and is dense. A dense sintered material has fewer pores, which are less likely to be starting points of cracking.
Although the first sintered material contains a plurality of pores, each pore is less likely to be a starting point of cracking. This is because most of pores with an average cross-sectional area of 500 μm² or less have a small cross-sectional area. Pores with a small cross-sectional area are less likely to be starting points of cracking.

### (Productivity)

The first sintered material is produced, for example, by sintering a dense green compact with a relative density of 93% or more at a relatively low temperature. A low sintering temperature can reduce thermal energy.

A sintered material with a relative density of 93% or more can be produced by sintering a green compact with a relatively low density, for example, a green compact with a relative density of approximately 90%, at a high temperature at which a liquid phase is formed. However, high-temperature sintering tends to increase the pore size. A test example 1 described later may be referred to with respect to this point. Large pores tend to be starting points of cracking. Pores as starting points of cracking decrease the strength of the sintered material. In contrast, the dense green compact can be sintered at a relatively low temperature to produce a dense sintered material with small pores. The test example 1 described later may be referred to with respect to this point.
Without high-temperature sintering, a sintered material with high shape accuracy and dimensional accuracy can be easily produced. This tends to result in a high yield.
The dense green compact has good cutting properties. Thus, if necessary, cutting the green compact before sintering tends to reduce the processing time. Furthermore, a sintered material with predetermined dimensions and shape can be more easily produced. This tends to result in a higher yield.

(2) A sintered material according to another embodiment of the present disclosure contains

a parent phase composed of a metal, and

a plurality of pores present in the parent phase,

wherein the pores in a cross section have an average perimeter of 100 μm or less, and

the sintered material has a relative density in the range of 93% to 99.5%.

The sintered material according to the other embodiment of the present disclosure may be hereinafter referred to as a second sintered material.

As described below, the second sintered material is less susceptible to cracking caused by pores and therefore has high strength. The second sintered material also has high productivity for the same reason as the first sintered material.
The second sintered material has a relative density of 93% or more and is dense. A dense sintered material has fewer pores, which are less likely to be starting points of cracking.
Although the second sintered material contains a plurality of pores, each pore is less likely to be a starting point of cracking. This is because most of the pores with an average perimeter of 100 μm or less have a small perimeter, and the pores with a small perimeter have a small cross-sectional area.

(3) In an embodiment of the first sintered material,

the pores in a cross section have an average perimeter of 100 μm or less.

In this embodiment, most of the pores have a small cross-sectional area and a small perimeter. Such pores are less likely to be starting points of cracking.

(4) In an embodiment of the first sintered material or the second sintered material,

the relative density is 96.5% or more.

This embodiment has fewer pores. Thus, pores are less likely to be starting points of cracking.

(5) In an embodiment of the first sintered material or the second sintered material,

the pores have an average maximum diameter in the range of 5 μm to 30 μm.

Like pores with a small cross-sectional area or pores with a small perimeter, most of pores with an average maximum diameter of 30 μm or less are short and small. Such pores are less likely to be starting points of cracking. Furthermore, pores with an average maximum diameter of 5 μm or more are not too small, so that the pressure for forming a green compact is less likely to be too high. Thus, this embodiment has high productivity.

(6) In an embodiment of the first sintered material or the second sintered material,

the metal is an iron-based alloy, and

the iron-based alloy contains at least one element selected from the group consisting of C, Ni, Mo, and B.

A steel composed of an iron-based alloy containing the above-mentioned element, for example, an iron-based alloy containing C has high strength. Thus, this embodiment has high strength.

(7) A method for producing a sintered material according to an embodiment of the present disclosure includes the steps of:

compressing a raw powder to produce a green compact with a relative density in the range of 93% to 99.5%; and

sintering the green compact,

wherein the raw powder contains a powder composed of an iron-based material with a Vickers hardness Hv in the range of 80 to 200, and

a sintering temperature in the step of sintering the green compact is 1000° C. or more and less than 1300° C.

As described below, a high-strength sintered material can be produced with high productivity by a method for producing a sintered material according to the present disclosure.

### (Strength)

A dense green compact with a relative density of 93% or more is used to produce a sintered material with a relative density of 93% or more. Such a sintered material has fewer pores and is dense, and therefore the pores are less likely to be starting points of cracking.
The iron-based material may typically be an iron-based alloy. Iron-based alloys generally have high strength. Thus, high-strength sintered materials are produced.
Typically, a sintered material thus produced has pores with an average cross-sectional area of 500 μm² or less. A sintered material thus produced has pores with an average perimeter of 100 μm or less. In such a sintered material, as described above, each pore is less likely to be a starting point of cracking.

### (Productivity)

The powder composed of an iron-based material and with the specific Vickers hardness Hv is compressed to produce the dense green compact. Furthermore, even sintered at a low temperature of less than 1300° C., the dense green compact forms the dense sintered material. Thus, sintering at high temperatures of 1300° C. or more or even 1400° C. or more is unnecessary. This can reduce thermal energy.
Without high-temperature sintering, a sintered material with high shape accuracy and dimensional accuracy can be easily produced. This tends to result in a high yield.

(8) An embodiment of a method for producing a sintered material according to the present disclosure

further includes the step of cutting the green compact before sintering the green compact.

The green compact before sintering has better cutting properties than sintered materials after sintering. Thus, this embodiment can reduce the processing time of the cutting. Due to good cutting, a sintered material with high shape accuracy and dimensional accuracy can be easily produced. Thus, the embodiment can further increase the yield.

(9) In an embodiment of a method for producing a sintered material according to the present disclosure,

the powder composed of the iron-based material contains a powder composed of an iron-based alloy, and

the iron-based alloy contains at least one element of 0.1% to 2.0% by mass Mo and 0.5% to 5.0% by mass Ni.

According to this embodiment, an alloy powder with a Vickers hardness Hv in the range of 80 to 200 can be easily produced.

### Details of Embodiments of Present Disclosure

A sintered material according to an embodiment of the present disclosure and a method for producing a sintered material according to an embodiment of the present disclosure are described below with reference to the accompanying drawings.

### [Sintered Material]

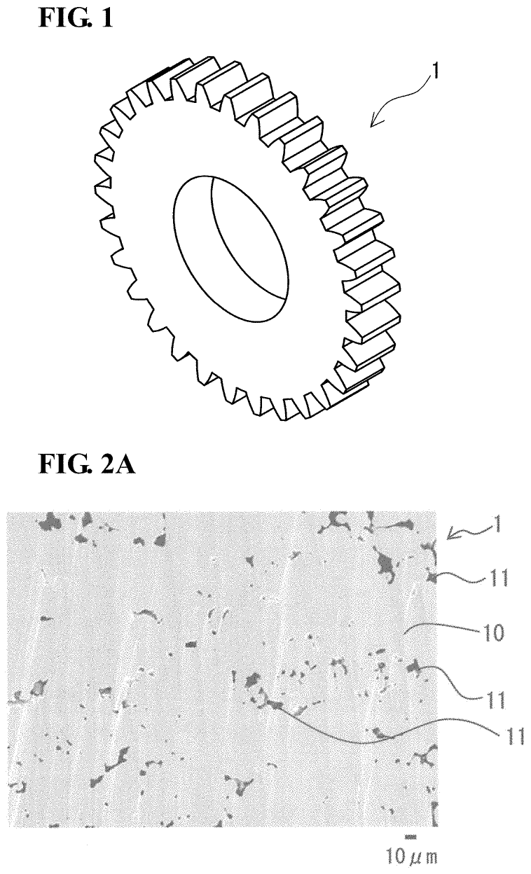

A sintered material 1 according to an embodiment is described below with reference mainly to FIG. 1.

FIG. 1 illustrates an external gear as an example of a sintered material 1 according to an embodiment.

### (Outline)

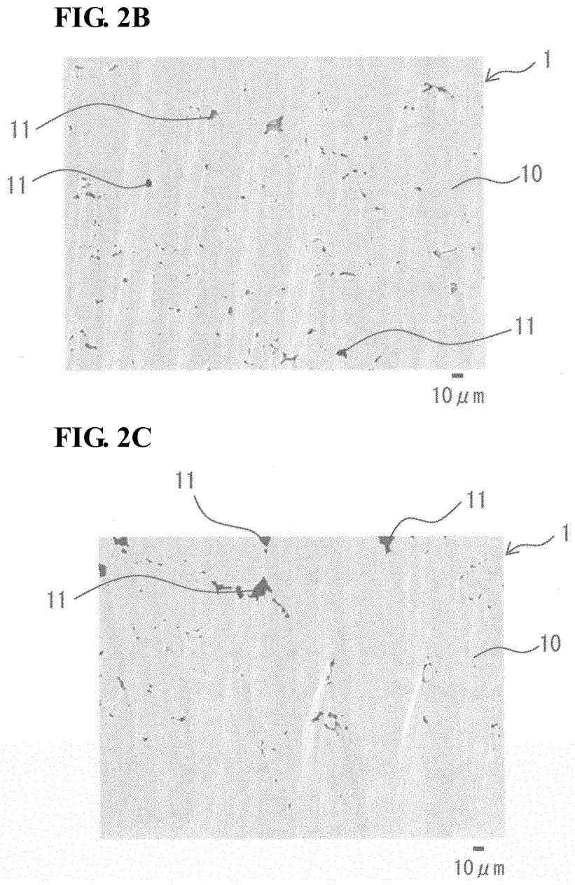

The sintered material 1 according to the embodiment is a dense sintered material composed mainly of a metal. The sintered material 1 has small pores in a cross section thereof. More specifically, the sintered material 1 according to the embodiment has a parent phase 10 composed of a metal and pores 11 present in the parent phase 10 (see FIG. 2 described later). The sintered material 1 according to the embodiment has a relative density in the range of 93% to 99.5%. In an example of the sintered material 1 according to the embodiment, the pores 11 in a cross section have an average cross-sectional area of 500 μm² or less. In another example of the sintered material 1 according to the embodiment, the pores 11 in a cross section have an average perimeter of 100 μm or less.

The average cross-sectional area of the pores 11 is a value obtained by taking a cross section of the sintered material 1, determining the cross-sectional area of each pore 11 in the cross section, and averaging the cross-sectional areas.

The average perimeter of the pores 11 is a value obtained by taking a cross section of the sintered material 1, determining the length of the contour of each pore 11 in the cross section, and averaging the lengths of the contours.

Methods for measuring the cross-sectional area of pores, the perimeter of pores, as well as the maximum diameter of pores, the aspect ratio of pores, and the relative density described later are described later in detail in test examples.

The sintered material 1 is described in more detail below.

### (Composition)

The metal constituting the parent phase 10 of the sintered material 1 according to the embodiment may be a pure metal or an alloy. For example the pure metal may be iron, nickel, titanium, copper, aluminum, or magnesium. For example the alloy may be an iron-based alloy, a titanium-based alloy, a copper-based alloy, an aluminum-based alloy, or a magnesium-based alloy. Alloys generally have higher strength than pure metals. Thus, the sintered material 1 containing an alloy as the parent phase 10 has high strength.

Iron-based alloys contain an additive element and the remainder composed of Fe (iron) and impurities and are alloys richest in Fe. The additive element may be at least one element selected from the group consisting of carbon (C), nickel (Ni), molybdenum (Mo), and boron (B). An iron-based alloy containing these elements in addition to Fe, for example, steel has high strength, such as high tensile strength. Thus, the sintered material 1 having the parent phase 10 composed of an iron-based alloy containing such an additive element has high strength. The strength tends to increase with each element content. If each element content is not too high, a decrease in toughness and embrittlement are suppressed, and the toughness tends to be high.

Iron-based alloys containing C, typically carbon steel, have high strength. The C content may range from 0.1% to 2.0% by mass. The C content may range from 0.1% to 1.5% by mass, 0.1% to 1.0% by mass, or 0.1% to 0.8% by mass. Each element content is a mass ratio based on 100% by mass of the iron-based alloy.

Ni contributes not only to improvement in strength but also to improvement in toughness. The Ni content may range from 0% to 5.0% by mass. The Ni content may range from 0.1% to 5.0% by mass, 0.5% to 5.0% by mass, 4.0% or less by mass, or 3.0% or less by mass.

Mo and B contribute to improvement in strength. In particular, Mo tends to increase the strength.

The Mo content may range from 0% to 2.0% by mass, 0.1% to 2.0% by mass, or 1.5% or less by mass.

The B content may range from 0% to 0.1% by mass or 0.001% to 0.003% by mass.

Examples of other additive elements include manganese (Mn), chromium (Cr), and silicon (Si). Each of these element contents may range from 0.1% to 5.0% by mass.

The total composition of the sintered material 1 can be measured by energy dispersive X-ray analysis (EDX or EDS) or high-frequency inductively coupled plasma spectroscopy (ICP-OES).

### (Microstructure)

Although the sintered material 1 according to the embodiment includes the pores 11 in a cross section, each of the pores 11 is small. Thus, each pore 11 is less likely to be a starting point of cracking. Because cracking caused by the pores 11 is less likely to occur, the sintered material 1 has high strength.

### <<Cross-Sectional Area>>

When the pores 11 have an average cross-sectional area of 500 μm² or less, most of the pores 11 in the sintered material 1 have a small cross-sectional area. The smaller the average cross-sectional area is, the smaller a cross-sectional area of each of the pores 11 is. Small pores 11 are less likely to be starting points of cracking. To reduce the occurrence of cracking caused by the pores 11, the average cross-sectional area is preferably 480 μm² or less, more preferably 450 μm² or less, particularly preferably 430 μm² or less.

The average cross-sectional area of the pores 11 tends to decrease with increasing relative density of the sintered material 1. For example, the compacting pressure in a process of producing the sintered material 1 can be increased to increase the relative density of the green compact and thereby increase the relative density of the sintered material 1. This tends to decrease the average cross-sectional area. However, an excessively high compacting pressure tends to result in a long demolding time and a short life of the die assembly. This can reduce productivity. To improve productivity, the average cross-sectional area may be 20 μm² or more or even 30 μm² or more.

### <<Perimeter>>

When the pores 11 have an average perimeter of 100 μm or less, most of the pores 11 in the sintered material 1 have a small perimeter. Pores 11 with a small perimeter have a small cross-sectional area. Pores 11 with a smaller average perimeter have a smaller cross-sectional area. Small pores 11 are less likely to be starting points of cracking. To reduce the occurrence of cracking caused by the pores 11, the average perimeter is preferably 90 μm or less, more preferably 80 μm or less, particularly preferably 70 μm or less.

The average perimeter of the pores 11 tends to decrease with increasing relative density of the sintered material 1. To prevent an excessively high compacting pressure as described above and improve the productivity, the average perimeter may be 10 μm or more or even 15 μm or more.

The pores 11 preferably have an average cross-sectional area of 500 μm² or less and an average perimeter of 100 μm or less. Most of the pores 11 in the sintered material 1 have a small cross-sectional area and a small perimeter. Thus, each pore 11 is less likely to be a starting point of cracking. To reduce the occurrence of cracking caused by the pores 11, the average cross-sectional area and the average perimeter are preferably smaller, as described above.

### <<Maximum Diameter>>

Furthermore, the pores 11 preferably have a small average maximum diameter. The average maximum diameter of the pores 11 is a value obtained by taking a cross section of the sintered material 1, determining the maximum diameter of each pore 11 in the cross section, and averaging the maximum diameters.

For example, the pores 11 have an average maximum diameter in the range of 5 μm to 30 μm. When the average is 30 μm or less, most of the pores 11 in the sintered material 1 are short and small. Such pores 11 are less likely to be starting points of cracking. To reduce the occurrence of cracking caused by the pores 11, the average is preferably 28 μm or less, more preferably 25 μm or less, particularly preferably 20 μm or less. When the average is 5 μm or more, the pores 11 are not too small. To prevent an excessively high compacting pressure as described above and improve the productivity, the average may be 8 μm or more or even 10 μm or more. In terms of the balance between high strength and high productivity, the average ranges from 10 μm to 25 μm, for example.

Furthermore, the pores 11 preferably have a small maximum value of the maximum diameters. This is because the pores 11 are less likely to be starting points of cracking. The maximum value is preferably 30 μm or less, more preferably 28 μm or less, particularly preferably 25 μm or less, for example.

The minimum value of the maximum diameters of the pores 11 preferably ranges from, for example, 3 μm to 20 μm, more preferably 5 μm to 18 μm or less, in terms of improved productivity, as described above.

### <<Shape>>

In a cross section of the sintered material 1, the pores 11 typically have an irregular shape (see also FIG. 2). One reason for the irregular shape of the pores 11 instead of a simple curved shape, such as a circular or elliptical shape, is that a dense green compact is sintered at a relatively low temperature, as described later. In FIG. 2, particulate regions with a deep color, mainly black particulate regions, and particulate regions with a white border are the pores 11, and the remainder is the parent phase 10.

### (Relative Density)

The sintered material 1 according to the embodiment has a relative density in the range of 93% to 99.5%. In other words, the pores 11 constitute 0.5% to 7% of the sintered material 1. At a pore content in this range, the pores 11 are fewer, and the sintered material 1 is dense. The fewer pores 11 are less likely to be starting points of cracking. The number of pores 11 decreases with increasing relative density. To reduce the occurrence of cracking caused by the pores 11, the relative density is preferably 94% or more, more preferably 95% or more, still more preferably 96% or more, particularly preferably 96.5% or more. The relative density may be 97% or more, 98% or more, or 99% or more.

The sintered material 1 with a relative density of 99.5% or less can have high productivity without excessively high compacting pressure. To improve productivity, the relative density may be 99% or less.

In terms of the balance between high strength and high productivity, the sintered material 1 has a relative density in the range of 94% to 99%, for example.

### (Applications)

The sintered material 1 according to the embodiment can be used for various general structural parts, for example, mechanical parts. Examples of the mechanical parts include various gears including sprockets, rotors, rings, flanges, pulleys, and bearings. The sintered material 1 according to the embodiment is dense, has high strength, and can be small. Thus, the sintered material 1 according to the embodiment can be suitably used for a gear, for example, a transmission of an automobile, which is desired to have high strength and to be small and lightweight.

### (Main Advantageous Effects)

The sintered material 1 according to the embodiment has a high relative density, fewer pores 11, and small pores 11 in a cross section. In the sintered material 1 according to the embodiment, the pores 11 are less likely to be starting points of cracking, and the strength is high. Furthermore, when at least one of the pores 11 is a pore opened on a surface of the sintered material 1, that is, an open pore, the sintered material 1 advantageously has high durability and quietness, as described below.

Durability

An open pore can hold lubricant. When the sintered material 1 is a sliding member, such as a gear, lubricant held in an open pore reduces the seizure of the mating member. Such a sliding member composed of the sintered material 1 can be used well for extended periods.

Quietness

An open pore can absorb sound. Sound absorbed by a small open pore as described above tends to be attenuated.

### [Method for Producing Sintered Material]

The sintered material 1 according to the embodiment can be produced, for example, by a method for producing a sintered material including the following steps.

(First step) A raw powder is compressed to produce a green compact with a relative density in the range of 93% to 99.5%.

(Second step) The green compact is sintered. The sintering temperature is below the liquid phase temperature.

A dense green compact with a relative density of 93% or more can be used to produce a dense sintered material with a relative density in the range of 93% to 99.5%, that is, a sintered material with fewer pores, even at a relatively low sintering temperature, for example, below the liquid phase temperature. This is because the sintered material typically maintains the relative density of the green compact. The pores constitute 0.5% to 7% of the green compact. However, each pore becomes smaller by compression. A dense green compact with small pores can be sintered at the relatively low temperature to produce a dense sintered material with small pores. In other words, the sintered material thus produced substantially maintains the size and number of pores of the green compact. The sintered material has fewer small pores, which are less likely to be starting points of cracking, and has high strength.

The method for producing a sintered material according to the embodiment includes the first and second steps described above. In particular, the raw powder contains a powder composed of an iron-based material with a Vickers hardness Hv in the range of 80 to 200. A powder composed of an iron-based material may be hereinafter referred to as an iron-based powder. The sintering temperature in the second step is 1000° C. or more and less than 1300° C. The dense green compact is easily produced by using an iron-based powder with a Vickers hardness Hv in the above range, as described later.

Each step is described below.

### (First Step)

### <Preparation of Raw Powder>

The raw powder contains a metallic powder. The metallic powder is preferably composed of a metal that is neither too soft nor too hard. The metallic powder that is not too hard is easily plastically deformed by compression. Thus, a dense green compact with a relative density of 93% or more can be easily produced. A green compact with a relative density of 99.5% or less, that is, a green compact with pores can be easily produced by using the metallic powder that is not too soft.

The raw powder may contain a metallic powder with an appropriate composition depending on the composition of the parent phase of the sintered material. The hardness of the metallic powder may be adjusted in accordance with the composition of the metallic powder. The hardness of the metallic powder can be adjusted by adjusting the composition, applying heat treatment to the metallic powder, or adjusting the heat-treatment conditions of the metallic powder. The composition of the metallic powder may be referred to in the above section (Composition) of [Sintered Material].

For example, to produce a sintered material with a parent phase composed of an iron-based material, the raw powder contains an iron-based powder. The iron-based material is pure iron or an iron-based alloy. When the iron-based material is an iron-based alloy in particular, a high-strength sintered material can be produced as described above. The iron-based powder can be produced by a water atomization process or a gas atomization process, for example.

To produce a sintered material with a parent phase composed of an iron-based alloy, the following raw powder may be used.

(1) The raw powder contains a first alloy powder composed of an iron-based alloy. The iron-based alloy constituting the first alloy powder has the same composition as that of the iron-based alloy constituting the parent phase of the sintered material.

(2) The raw powder contains a second alloy powder composed of an iron-based alloy and a third powder composed of a specified element. The iron-based alloy constituting the second alloy powder contains some of the additive elements contained in the iron-based alloy constituting the parent phase of the sintered material. The element constituting the third powder is one of the remaining additive elements among the additive elements. Thus, the third powder is composed of a single element.

(3) The raw powder contains a pure iron powder, the second alloy powder, and the third powder.

(4) The raw powder contains a pure iron powder and a third powder. The third powder is composed of one of the additive elements in the iron-based alloy of the parent phase.

For example, when the parent phase of the sintered material is an iron-based alloy containing at least one element selected from the group consisting of Ni, Mo, and B and C with the remainder composed of Fe and impurities, the second alloy powder may be composed of the following iron-based alloy. The iron-based alloy does not contain C but contains at least one element selected from the above group, and the remainder is composed of Fe and impurities. One example of the iron-based alloy contains at least one element of 0.1% to 2.0% by mass Mo and 0.5% to 5.0% by mass Ni. The iron-based alloy containing Mo and Ni in these ranges has various compositions with a Vickers hardness Hv in the range of 80 to 200. Thus, the powder composed of the iron-based alloy is easy to produce. The third powder may be a carbon powder or a powder composed of one element selected from the above group.

A powder composed of an iron-based material with a Vickers hardness Hv of 80 or more is not too soft. A green compact containing pores in a specific range as described above can be produced by using such a raw powder containing an iron-based powder. A powder composed of an iron-based material with a Vickers hardness Hv of 200 or less is not too hard. A dense green compact can be produced as described above by using such a raw material containing an iron-based powder. The Vickers hardness Hv may range from 90 to 190, 100 to 180, or 110 to 150.

The size of the raw powder can be appropriately selected. For example, the alloy powder or the pure iron powder may have an average particle size in the range of 20 μm to 200 μm or 50 μm to 150 μm. The third powder excluding a carbon powder has an average particle size in the range of approximately 1 μm to 200 μm, for example. The carbon powder has an average particle size in the range of approximately 1 μm to 30 μm, for example. The “average particle size” of a powder, as used herein, refers to the particle size at which the cumulative volume is 50% in a volumetric particle size distribution measured with a laser diffraction particle size distribution analyzer (D50).

### <Compacting>

A green compact with a higher relative density tends to result in a sintered material with a higher relative density and fewer pores finally produced. The sintered material also tends to have small pores. To decrease the number and size of pores, the green compact may have a relative density of 94% or more, 95% or more, 96% or more, 96.5% or more, 97% or more, or 98% or more.

The compacting pressure may be low for a green compact with a somewhat low relative density. This tends to increase the life of a die assembly, make it easy to remove a green compact from the die assembly, and decrease the demolding time, and thereby improves mass productivity. In terms of high mass productivity, the green compact may have a relative density of 99.4% or less or even 99.2% or less.

A green compact can typically be produced with a press machine equipped with a uniaxial pressing die assembly. The shape of the die assembly may depend on the shape of the green compact.

The shape of the green compact may conform with the final shape of the sintered material or may be different from the final shape of the sintered material. In the latter case, processing, such as cutting, may be performed in accordance with the final shape of the sintered material in a step after compacting. The cutting is preferably applied to the green compact before sintering, as described later.

A lubricant may be applied to the inner circumferential surface of the die assembly. The lubricant tends to prevent the raw powder from sticking to the die assembly. This tends to result in a green compact with a high density as well as high shape accuracy and dimensional accuracy. The lubricant is a higher fatty acid, metallic soap, fatty acid amide, or higher fatty acid amide, for example.

A higher compacting pressure tends to result in a denser green compact. The compacting pressure is 1560 MPa or more, for example. The compacting pressure may also be 1660 MPa or more, 1760 MPa or more, 1860 MPa or more, or 1960 MPa or more.

### (Second Step: Sintering)

As described above, the sintering temperature is below the liquid phase temperature and is relatively low. This can reduce thermal energy as compared with sintering at high temperatures at which a liquid phase is formed. Furthermore, as compared with the high-temperature sintering, a decrease in shape accuracy and a decrease in dimensional accuracy due to thermal contraction are less likely to occur. This facilitates the production of a sintered material with high shape accuracy and dimensional accuracy and can improve the yield of the sintered material. Thus, a method for producing a sintered material by sintering a dense green compact at a relatively low temperature can produce a sintered material with fewer small pores and with high shape accuracy and dimensional accuracy with high productivity.

The sintering temperature and the sintering time may be adjusted in accordance with the composition of the raw powder. In the method for producing a sintered material according to the embodiment using an iron-based powder, the sintering temperature is 1000° C. or more and less than 1300° C.

The thermal contraction tends to decrease with decreasing sintering temperature. Thus, a sintered material with high shape accuracy and dimensional accuracy can be easily produced. To reduce the energy and improve the shape accuracy and dimensional accuracy, the sintering temperature is preferably 1250° C. or less, more preferably less than 1200° C.

The sintering time tends to decrease with increasing sintering temperature in these ranges. This increases the productivity. To decrease the sintering time, the sintering temperature may be 1050° C. or more or even 1100° C. or more.

In terms of a reduction in energy and the balance between high accuracy and a reduction in sintering time, the sintering temperature is 1100° C. or more and less than 1200° C., for example.

The sintering time ranges from 10 minutes to 150 minutes, for example.

The sintering atmosphere is a nitrogen atmosphere or a vacuum atmosphere, for example. The pressure of the vacuum atmosphere is 10 Pa or less, for example. In a nitrogen atmosphere or a vacuum atmosphere, due to a low concentration of oxygen in the atmosphere, the green compact and the sintered material are less likely to be oxidized.

### (Another Step)

The method for producing a sintered material may further include the step of cutting the green compact before sintering the green compact. The cutting may be turning or rotating.

The green compact before sintering has better cutting properties than sintered materials after sintering or molten materials. In particular, green compacts with a relative density of 93% or more are easier to cut than green compacts with a relative density of less than 93%. For example, the cutting can be satisfactorily performed even at a high feed rate. Thus, a sintered material with high shape accuracy and dimensional accuracy can be easily produced. This tends to result in a high yield. Furthermore, an increase in feed rate results in a shorter cutting time. When a green compact is cut to form a compact in the final shape, for example, the green compact may be a simple-shaped green compact, such as a cylindrical body, a columnar body, or a rectangular parallelepiped. A dense green compact is easily compacted with high accuracy from a simple-shaped green compact even at a somewhat low compacting pressure. A compacting pressure that is not too high tends to result in a long life of the die assembly. Furthermore, for a simple-shaped green compact, the die assembly cost can be reduced. Thus, cutting the green compact before the sintering step contributes to mass production of the sintered material.

The method for producing a sintered material may include the step of heat treatment of the sintered material produced in the second step. For example, in the method for producing a sintered material according to the embodiment using the iron-based powder, the heat treatment may be carburizing followed by quenching and tempering, or carburizing and quenching followed by tempering. The conditions for the heat treatment may be appropriately adjusted in accordance with the composition of the sintered material. For the heat treatment conditions, known conditions may be referred to.

The method for producing a sintered material may include the step of finishing the sintered material after sintering. The finishing is polishing, for example. A sintered material with good surface properties or a sintered material with higher shape accuracy and dimensional accuracy can be produced by the finishing.

### (Main Advantageous Effects)

The method for producing a sintered material according to the embodiment can produce a sintered material with a high relative density, fewer pores, and small pores in a cross section, typically the sintered material 1 according to the embodiment, with high productivity.

### Test Example 1

Green compacts with different relative densities were sintered at various temperatures to produce sintered materials. The microstructure and strength of the sintered materials were examined.

The sintered materials were produced as described below.

A raw powder is used to produce a green compact.

The green compact is sintered.

The sintering is followed by carburizing and quenching and then by tempering.

The raw powder is a mixed powder containing an alloy powder composed of the following iron-based alloy and a carbon powder.

The iron-based alloy contains 2% by mass Ni, 0.5% by mass Mo, 0.2% by mass Mn, and the remainder composed of Fe and impurities. The iron-based alloy has a Vickers hardness Hv of 120, which satisfies the range of 80 to 200.

The carbon powder content is 0.3% by mass based on 100% by mass of the total mass of the mixed powder.

The alloy powder has an average particle size (D50) of 100 μm. The carbon powder has an average particle size (D50) of 5 μm.

The raw powder was compacted to form a columnar green compact. The green compact is 75 mm in outer diameter and 20 mm in thickness.

The green compact was formed by selecting the compacting pressure in the range of 1560 MPa to 1960 MPa such that the green compact of each sample had a relative density (%) in the range of approximately 85% to 99%. The relative density of the green compact increase with the compacting pressure. Table 1 shows the density (g/cm³) and relative density (%) of the green compact of each sample.

The density (g/cm³) of the green compact was determined by measuring the mass of the green compact and dividing the mass by the volume of the green compact. The density thus determined is the apparent density of the green compact. The relative density (%) of the green compact was determined by dividing the apparent density of the green compact by the true density, 7.8 g/cm³, of the green compact. The true density was determined from the composition of the raw powder used.

The green compact was sintered under the following conditions. The sintering was followed by carburizing and quenching and then by tempering under the following conditions to form the sintered material of each sample.

(Sintering Conditions) The sintering temperature (° C.) is 1130° C., 1450° C., or 1480° C. Table 1 shows the sintering temperature of each sample. The holding time is 20 minutes. The atmosphere is a nitrogen atmosphere.

(Carburizing and Quenching) 930° C.×90 minutes, carbon potential: 1.4% by mass⇒850° C.×30 minutes oil cooling

(Tempering) 200° C.×90 minutes

A columnar sintered material 75 mm in outer diameter and 20 mm in thickness was produced in this way. The parent phase of the sintered material is composed of the following iron-based alloy. The iron-based alloy contains 2% by mass Ni, 0.5% by mass Mo, 0.2% by mass Mn, 0.3% by mass C, and the remainder composed of Fe and impurities. The components of the sintered material were analyzed by ICP.

### (Description of Samples)

Sintered materials of samples No. 1 to No. 3 are produced by sintering a green compact with a relative density of 93% or more at 1130° C., that is, below the liquid phase temperature. FIGS. 2A to 2C are scanning electron microscope (SEM) images of a cross section of the sintered materials of the samples No. 1 to No. 3, respectively.

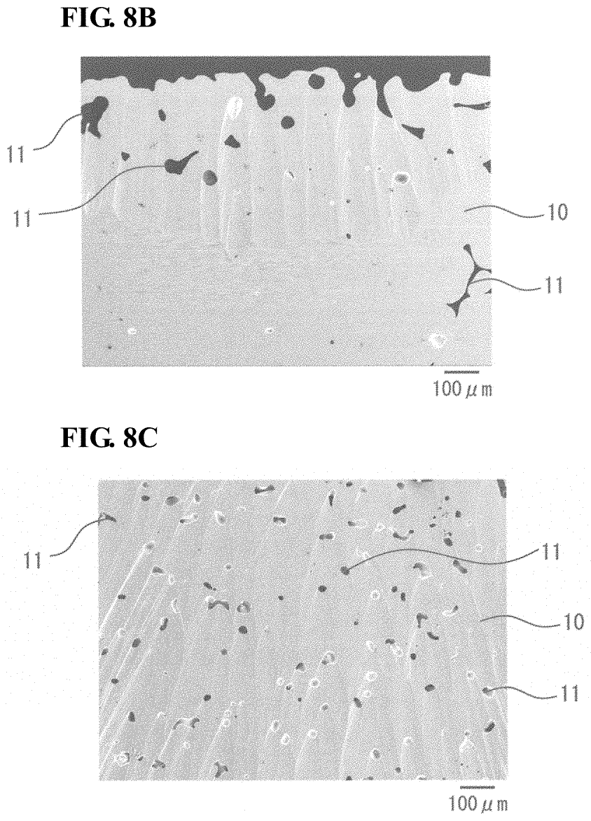

Sintered materials of samples No. 101 to No. 103 are produced by sintering a green compact with a relative density of less than 93% at the liquid phase temperature 1450° C. or 1480° C. FIGS. 8A to 8C are SEM images of a cross section of the sintered materials of the samples No. 101 to No. 103, respectively. In FIGS. 8A and 8B, the upper black region is the background.

### (Density and Relative Density)

The density (g/cm³) and relative density (%) of the sintered material of each sample prepared were examined.

The density (g/cm³) of the sintered material was determined in accordance with the Archimedes' principle. More specifically, the density is determined by measuring the mass of the sintered material in the air and the mass of the sintered material in pure water and calculating “(the density of water×the mass of the sintered material in the air)/(the mass of the sintered material in the air−the mass of the sintered material in water)”.

The relative density (%) of the sintered material is determined as described below.

A plurality of cross sections are taken from the sintered material. Each cross section is observed with a microscope, such as a SEM or optical microscope. The observed image is subjected to image analysis, and the area percentage of a metal component is regarded as the relative density.

When the sintered material is a tubular body as in the present example or a columnar body, a cross section is taken from a region on each end face side of the sintered material and a region near the center of the length in the axial direction of the sintered material. An end face of the sintered material is a circular face in the present example.

The end face region may be a region up to 3 mm in depth from a surface of the sintered material, depending on the length, or the thickness in the present example, of the sintered material. The region near the center may be a region up to 1 mm from the center of the length toward each end face, that is, a region of 2 mm in total, depending on the length of the sintered material. The cross section may be a plane crossing the axial direction, typically a plane perpendicular to the axial direction.

A plurality of, for example, 10 or more observation fields are chosen from each cross section. The area of one observation field is 500 μm×600 μm=300,000 μm², for example. When a plurality of observation fields are chosen from one cross section, it is preferable to equally divide the cross section and choose an observation field from each divided region.

The observed image of each observation field is subjected to image processing, such as binarization processing, and a region composed of metal is extracted from the processed image. The area of the region of metal thus extracted is determined. Furthermore, the ratio of the area of the region of metal to the area of the observation field is determined. This area ratio is regarded as the relative density of each observation field. The relative densities of the observation fields are averaged. The average is defined as the relative density (%) of the sintered material.

Ten or more observation fields are chosen from each of two end face regions. Ten or more observation fields are chosen from the region near the center. Then, the relative density of each observation field is determined, and a total of 30 or more relative densities are averaged. Table 1 shows this average as the relative density (%) of the sintered material.

The relative density of a green compact may be determined in the same manner as the relative density of a sintered material. As in the present example, when a green compact is compacted by uniaxial pressing, a cross section of the green compact may be taken from a region near the center of the length of the green compact in the pressing direction or from an end face region at both ends in the pressing direction. The cross section may be a plane crossing the pressing direction, typically a plane perpendicular to the pressing direction.

### (Microstructure Observation)

A cross section was taken from the sintered material of each sample prepared and was examined in terms of the pore size.

The pore size is determined as described below.

A cross section is taken from the sintered material of each sample. The cross section is observed with a SEM, and at least one field is chosen in the cross section. To measure the pore size, a total of 50 or more pores are extracted.

The magnification is adjusted in accordance with the pore size such that one or more pores exist in one field and the pore size can be accurately measured. For example, when a pore has the maximum diameter of 70 μm or less in the cross section observed at a magnification of 100 times, the magnification is increased to 300 times to observe the cross section again. The field number is increased until a total of 50 or more pores are observed. The size of one field in the samples No. 1 to No. 3 is approximately 355 μm× approximately 267 μm.

Pores are extracted from the field. As shown in FIGS. 2 and 8, the color of the parent phase 10 is different from the color of the pores 11. The SEM image is therefore subjected to binarization processing or the like to extract pores. Extraction of pores, measurement of the pore size, extraction of a region composed of metal used to measure the relative density, measurement of the area of the region, and the like can be easily performed by using a commercial image analysis system, commercial software, or the like.

### <Cross-Sectional Area>

The cross-sectional area of each pore extracted from the SEM image is determined. Furthermore, the average of the cross-sectional areas of the pores is determined. The average of the cross-sectional areas is determined by summing the cross-sectional areas of 50 or more extracted pores and dividing the sum total by the number of pores. Table 1 shows the average of the cross-sectional areas as an average cross-sectional area (μm²). Table 1 also shows the number of pores (N number) used to measure the cross-sectional areas and the like.

### <Perimeter>

The perimeter, that is, the length of the contour of each pore extracted from the SEM image is determined. Furthermore, the average of the perimeters of the pores is determined. The average of the perimeters is determined by summing the perimeters of 50 or more extracted pores and dividing the sum total by the number of pores. Table 1 shows the average of the perimeters as an average perimeter (μm).

### <Maximum Diameter>

The maximum diameter of each pore extracted from the SEM image is determined. Furthermore, the average of the maximum diameters is determined. The average of the maximum diameters is determined by summing the maximum diameters of 50 or more extracted pores and dividing the sum total by the number of pores. Table 1 shows the average of the maximum diameters (μm). The maximum diameter of each pore is determined as described below. In the SEM image, the outline of each pore is placed between two parallel lines, and the interval between the two parallel lines is measured. The interval is the distance in the direction perpendicular to the parallel lines. In each pore, a plurality of sets of parallel lines in any direction are chosen, and the intervals are measured. In each pore, the maximum value among the measured intervals is defined as the maximum diameter of the pore.

The maximum and minimum values of the maximum diameters of the pores were also determined. Table 1 shows the maximum value (μm) of the maximum diameters of the 50 or more pores. Table 1 also shows the minimum value (μm) of the maximum diameters of the 50 or more pores.

### <Circularity>

The circularity of each pore was determined as described below. The perimeter of each pore extracted from the SEM image and the perimeter of a circle with an area equivalent to the cross-sectional area of each pore are determined. (The perimeter of each pore/the perimeter of the circle) is defined as the circularity of the pore. Table 1 shows the average of the circularities of the 50 or more pores.

### <Strength>

Furthermore, the tensile strength (MPa) of the sintered material of each sample was examined. Table 1 shows the results.

The tensile strength was measured with a general-purpose tensile tester in a tensile test. A tensile test specimen conforms to the Japan Powder Metallurgy Association standard, JPMA M 04-1992, a sintered metal material tensile test specimen.

The test specimen is a flat sheet cut from a sintered material.

The test specimen is composed of a narrow portion and a wide portion located at both ends of the narrow portion. The narrow portion is composed of a central portion and a shoulder portion. The shoulder portion has an arcuate side surface from the central portion to the wide portion.

The size of the test specimen is described below. The gauge length is 30 mm.

Thickness: 5 mm

Length: 72 mm

Length of central portion: 32 mm

Width of central portion of narrow portion: 5.7 mm

Width of shoulder portion near narrow portion: 5.96 mm

Radius R of side surface of shoulder portion: 25 mm

Width of wide portion: 8.7 mm

TABLE 1

| Sample No. | | 101 | 102 | 103 | 1 | 2 | 3 |
|---|---|---|---|---|---|---|---|
| Green | Density | 6.85 | 7.09 | 7.09 | 7.33 | 7.56 | 7.70 |
| compact | (g/cm³) | | | | | | |
| | Relative density | 87.8 | 90.9 | 90.9 | 94.0 | 96.9 | 98.7 |
| | (%) | | | | | | |
| | Sintering temperature | 1480 | 1480 | 1450 | 1130 | 1130 | 1130 |
| | (° C.) | | | | | | |
| Sintered | Sintered density | 7.44 | 7.50 | 7.30 | 7.35 | 7.57 | 7.71 |
| material | (g/cm³) | | | | | | |
| | Relative density | 95.4 | 96.2 | 93.6 | 94.2 | 97.1 | 98.8 |
| | (%) | | | | | | |
| | Average | 25373 | 6298 | 6933 | 424 | 298 | 259 |
| | cross-sectional area | | | | | | |
| | (μm²) | | | | | | |
| | Average perimeter | 526 | 202 | 260 | 64 | 53 | 45 |
| | (μm) | | | | | | |
| | Maximum diameter | 129 | 60 | 74 | 18 | 15 | 14 |
| | (average) | | | | | | |
| | (μm) | | | | | | |
| | Maximum diameter | 198 | 81 | 98 | 24 | 20 | 18 |
| | (maximum value) | | | | | | |
| | (μm) | | | | | | |
| | Maximum diameter | 78 | 45 | 55 | 13 | 11 | 9 |
| | (minimum value) | | | | | | |
| | (μm) | | | | | | |
| | Circularity | 3.68 | 4.42 | 3.45 | 2.99 | 3.19 | 3.26 |
| | N number (—) | 59 | 60 | 173 | 169 | 212 | 162 |
| | Tensile strength (MPa) | 1082 | 1213 | 1105 | 1425 | 1523 | 1620 |

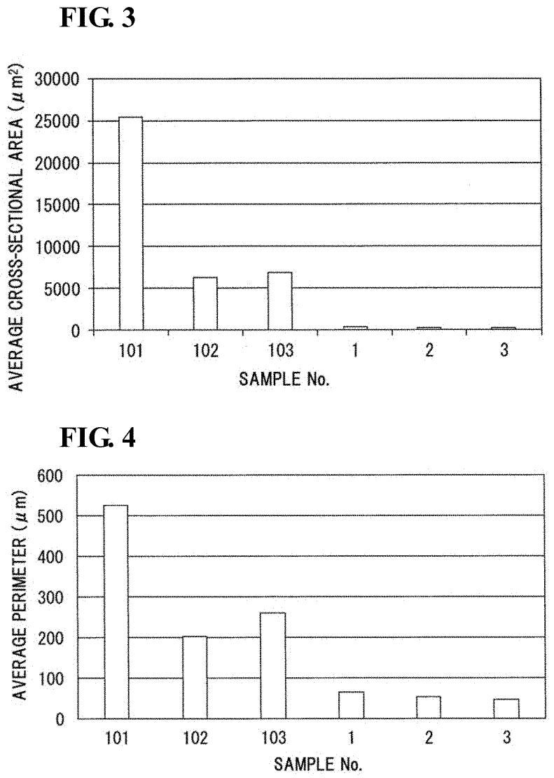

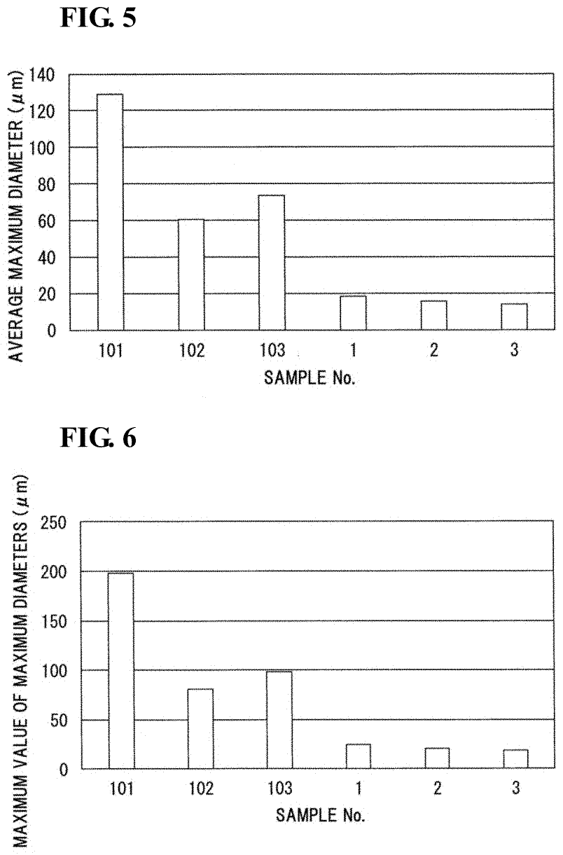

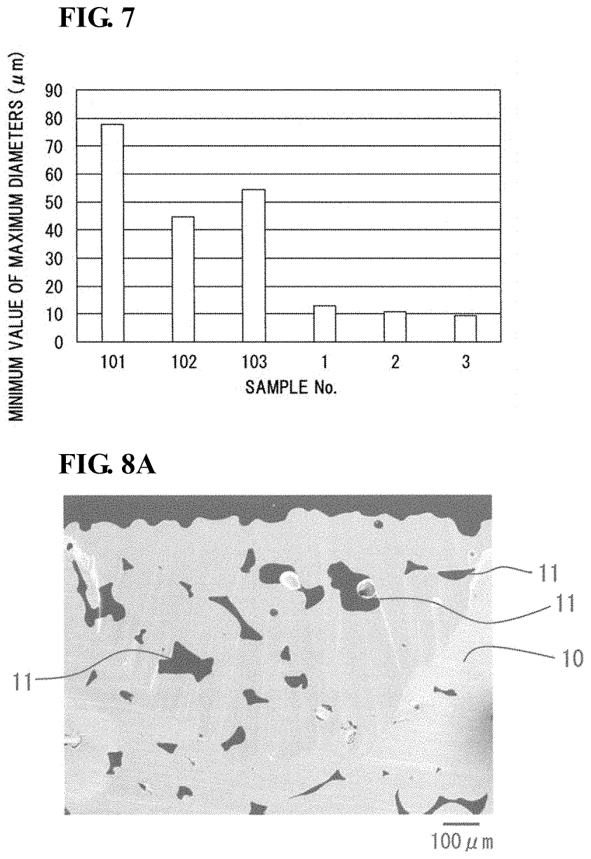

FIGS. 3 to 7 are graphs showing the average cross-sectional area (μm²), the average perimeter (μm), the average maximum diameter (μm), the maximum value (μm) of the maximum diameters, and the minimum value (μm) of the maximum diameters, respectively, of the pores in the sintered material of each sample. The horizontal axis of each graph indicates the sample number. The vertical axis of each graph indicates the average cross-sectional area (μm²) of the pores in FIG. 3, the average perimeter (μm) of the pores in FIG. 4, the average maximum diameter (μm) of the pores in FIG. 5, the maximum value (μm) of the maximum diameters of the pores in FIG. 6, and the minimum value (μm) of the maximum diameters of the pores in FIG. 7.

As shown in Table 1 and FIG. 3, the pores in the sintered materials of the samples No. 1 to No. 3 have a smaller average cross-sectional area than the pores in the sintered materials of the samples No. 101 to No. 103. The sintered materials of the samples No. 1 to No. 3 are hereinafter referred to as high-density compacted samples. The sintered materials of the samples No. 101 to No. 103 are hereinafter referred to as high-temperature sintered samples.

Quantitatively, the average cross-sectional area of the pores in the high-density compacted samples is 500 μm² or less, particularly 450 μm² or less here. In the sintered materials of the samples No. 2 and No. 3, which have a relative density of 96.5% or more, the average cross-sectional area of the pores is 400 μm² or less, particularly 300 μm² or less, and is smaller.

As shown in Table 1 and FIG. 4, the average perimeters of the pores are smaller in the high-density compacted samples than in the high-temperature sintered samples. Quantitatively, in the high-density compacted samples, the average perimeters of the pores are 100 μm or less, particularly 70 μm or less here. In the sintered materials of the samples No. 2 and No. 3, the average perimeters of the pores are 55 μm or less and are smaller.

In the high-temperature sintered samples, the sintered material has a relative density of 93% or more, and as shown in Table 1 and FIGS. 8A to 8C the pores 11 have a large cross-sectional area and a large perimeter. One possible reason for this is described below. The green compacts of the high-temperature sintered samples have a smaller relative density and a larger number of pores than those of the high-density compacted samples. When a green compact with a large number of pores is sintered at a high temperature, such as a liquid phase temperature, pores are easily removed to some extent, but a plurality of bubbles tend to be merged inside and remain as large pores, as shown in FIGS. 8A to 8C. Thus, pores with a large cross-sectional area and a large perimeter tend to remain.

In contrast, in the high-density compacted samples, as shown in Table 1 and FIGS. 2A to 2C, the pores 11 are somewhat large in number but have a small cross-sectional area and a small perimeter. The pores 11 in the sintered material of the sample No. 3 among the sintered materials of the samples No. 1 to No. 3 are fewest, have the smallest cross-sectional area, and the smallest perimeter. One possible reason for this is described below. The green compacts of the high-density compacted samples have a large relative density and fewer pores. Furthermore, compression tends to decrease the pore size. When such a green compact is sintered at a relatively low temperature, bubbles are less likely to be removed and tend to remain, but each pore remains small. Thus, as shown in FIGS. 2A to 2C, pores with a small cross-sectional area and a small perimeter tend to remain. A green compact with a smaller number of pores tends to result in pores with a smaller cross-sectional area and a smaller perimeter in the sintered material.

The high-density compacted samples have higher tensile strength and higher strength than the high-temperature sintered samples. The high-density compacted samples have a tensile strength 15% or more higher than the sample No. 102, which has the highest tensile strength among the high-temperature sintered samples. The reason for this is probably that the small pores in the high-density compacted samples are less likely to be starting points of cracking.

This test also shows the following.

(1) As shown in Table 1 and FIG. 5, the average maximum diameter of the pores is smaller in the high-density compacted samples than in the high-temperature sintered samples. Quantitatively, the average maximum diameter in the high-density compacted samples is 30 μm or less, particularly 20 μm or less here. The average maximum diameter in the high-density compacted samples is 5 μm or more, particularly 10 μm or more here. These pores are small but not too small.

(2) As shown in Table 1 and FIGS. 6 and 7, the maximum and minimum values of the maximum diameters of the pores are also smaller in the high-density compacted samples than in the high-temperature sintered samples. Quantitatively, the maximum value of the maximum diameters in the high-density compacted samples is 30 μm or less, particularly 25 μm or less here. Furthermore, the difference between the average and the maximum value of the maximum diameters is smaller in the high-density compacted samples than in the high-temperature sintered samples. Thus, the maximum diameters of the high-density compacted samples are closer to uniform. The minimum value of the maximum diameters in the high-density compacted samples is 20 μm or less, particularly 5 μm to 15 μm. This also shows that the pores in the high-density compacted samples are small but not too small.

(3) As shown in Table 1, the high-density compacted samples have a smaller circularity than the high-temperature sintered samples. Quantitatively, the high-density compacted samples have a circularity of 3.4 or less, more specifically 3.3 or less here.

The test also showed that a sintered material with a relative density in the range of 93% to 99.5% and with small pores can be produced by sintering a green compact with a relative density in the range of 93% to 99.5% at a relatively low temperature below the liquid phase temperature. It was also shown that a powder composed of an iron-based alloy with a Vickers hardness Hv in the range of 80 to 200 can be used to produce a dense green compact as described above.

As described above, pores in a dense sintered material with a relative density in the range of 93% to 99.5% and with small pores are less likely to be starting points of cracking, and the sintered material has high strength. Thus, such a sintered material is expected to be suitably used for various parts that require high strength. Furthermore, if at least one pore is an open pore, high durability and quietness due to a lubricant held can also be expected. Thus, such a sintered material is expected to be suitably used for sliding members, such as gears, that require lubricity and parts that require quietness.

The present disclosure is defined by the appended claims rather than by these embodiments. All modifications that fall within the scope of the claims and the equivalents thereof are intended to be embraced by the claims.

For example, in the test example 1, the composition and the production conditions of the sintered material may be changed. A sintered material may have a composition other than the iron-based materials, for example. Production conditions, for example, the relative density of a green compact, the sintering temperature, and the like may be changed.

### REFERENCE SIGNS LIST

1 sintered material
10 parent phase
11 pore

1. A sintered material comprising:
a parent phase composed of an iron-based alloy; and
a plurality of pores present in the parent phase,
wherein the pores in a cross section have an average cross-sectional area of 300 μm² or less,
the pores in a cross section have an average perimeter of 55 μm or less,
the pores in a cross section have other shapes than circular or elliptical shape, and
the sintered material has a relative density in the range of 93% to 99.5%.

2.-9. (canceled)

10. The sintered material according to claim 1, wherein the relative density is 96.5% or more.

11. The sintered material according to claim 1, wherein the pores have an average maximum diameter in the range of 5 μm to 30 μm.

12. The sintered material according to claim 10, wherein the pores have an average maximum diameter in the range of 5 μm to 30 μm.

13. The sintered material according to claim 1, wherein
the iron-based alloy contains at least one element selected from the group consisting of C, Ni, Mo, Mn and B.

14. The sintered material according to claim 10, wherein
the iron-based alloy contains at least one element selected from the group consisting of C, Ni, Mo, Mn and B.

15. The sintered material according to claim 11, wherein
the iron-based alloy contains at least one element selected from the group consisting of C, Ni, Mo, Mn and B.

16. The sintered material according to claim 12, wherein
the iron-based alloy contains at least one element selected from the group consisting of C, Ni, Mo, Mn and B.

17. A method for producing a sintered material, comprising the steps of:
compressing a raw powder to produce a green compact with a relative density in the range of 93% to 99.5%; and
sintering the green compact and producing the sintered material,
wherein the raw powder contains a powder composed of an iron-based alloy with a Vickers hardness Hv in the range of 80 to 200,
the powder composed of the iron-based alloy has an average particle size in the range of 100 μm to 200 μm,
a sintering temperature in the step of sintering the green compact is below a liquid phase temperature and 1000° C. or more and less than 1200° C.,
the pores in a cross section of the sintered material have an average cross-sectional area of 300 μm² or less,
the pores in a cross section of the sintered material have an average perimeter of 55 μm or less.

18. The method for producing a sintered material according to claim 17, further comprising the step of cutting the green compact before sintering the green compact.

19. The method for producing a sintered material according to claim 17, wherein
the iron-based alloy contains at least one element selected from the group consisting of 0.1% to 2.0% by mass Mo, 0.5% to 5.0% by mass Ni, and 0.1% to 5.0% by mass Mn.

20. The method for producing a sintered material according to claim 18, wherein
the iron-based alloy contains at least one element selected from the group consisting of 0.1% to 2.0% by mass Mo, 0.5% to 5.0% by mass Ni, and 0.1% to 5.0% by mass Mn.
